(19) United States
(12) Patent Application Publication
(10) Pub. No.: US 2024/0134368 A1
(43) Pub. Date: Apr. 25, 2024

(54) Method and System for Evaluating a Necessary Maintenance Measure for a Machine, More Particularly for a Pump

(71) Applicant: KSB SE & Co. KGaA, Frankenthal (DE)

(72) Inventors: Christoph EMDE, Luxemburg (LU); Stefan LAUE, Frankenthal (DE)

(21) Appl. No.: 18/279,673

(22) PCT Filed: Feb. 22, 2022
(86) PCT No.: PCT/EP2022/054403

§ 371 Date: Aug. 31, 2023

(30) Foreign Application Priority Data
Mar. 12, 2021 (DE) 10 2021 104 826.5

(51) Int. Cl. G05B 23/02; G01M 99/00

(52) U.S. Cl. CPC G05B 23/0283; G01M 99/005

(57) ABSTRACT

A method for evaluating a necessary maintenance measure of a machine includes determining one or more influencing variables, receiving the one or more influencing variables, ascertaining a risk of failure and/or a likelihood of failure, and generating a recommendation. The one or more influencing variables are relevant to the wear or damage of a machine component. The one or more influencing variables are received by way of the evaluation unit. The risk or likelihood of failure are ascertained by way of an estimation model. The recommendation is associated with a maintenance measure and is generated by way of the evaluation unit on the basis of the ascertained risk of failure and/or the likelihood of failure.

### CROSS REFERENCE TO RELATED APPLICATIONS

This application claims priority under 35 U.S.C. § 119 from German Patent Application No. 102021104826.5, filed Mar. 1, 2021, the entire disclosure of which is herein expressly incorporated by reference.

### BACKGROUND

The disclosure relates to a method for evaluating a necessary maintenance measure for a machine, in particular for a pump.

Existing mechanical industrial installations, in particular pumps, have to be monitored at all times in terms of their correct functioning and operation. One particular concern here is the early recognition of possible wear and component faults in order to be able to create appropriate warning messages and take maintenance measures as promptly as possible before the occurrence of greater damage to the machine, as far as total failure of the machine.

Accurately acquiring the current wear state of a machine is often difficult and unreliable in practice. This is all the more true since machines, in particular those having rotatable components, consist of various sub-component parts that are susceptible to wear to different extents. Such machines are also subject to numerous external influences that may have an effect on the advancement of wear of the machine. Complexity is increasing due to the enormous number of relevant influencing factors, and acquiring the current wear state is barely achievable in reality.

### SUMMARY

The subject matter of the present disclosure therefore deals with a method for predicting possible risks of wear or failure in order to be able to take appropriate maintenance measures corresponding to a risk-based evaluation.

This object is achieved by a method according to the features of claim 1. Further advantages of the method are the subject of the dependent claims.

According to the disclosure, it is proposed for one or more influencing variables relevant to the wear or damage of a machine and/or of a component of the machine to first be determined by the machine. A relevant influencing variable is understood to mean a measurable variable that has a non-negligible influence on the advancement of wear of the machine or at least one component of the machine and thus also on the likelihood of failure or the risk of failure of the component under consideration or the machine. Influencing variables may be divided into operation-related and operation-independent influences. The former vary depending on the current operating state or any operating parameters, such as pressure values, vibrations, operating points, temperature values, operating durations, downtimes, etc. Operation-independent influencing variables are more or less fixed, and include material and assembly quality, manufacturing tolerances, age of the components, any prior damage, etc.

The determined influencing variables are transmitted by the machine to an evaluation unit, which supplies the received influencing variables to an estimation model. Such a model is able to determine the risk of failure and/or a likelihood of failure for the machine and/or a component of the machine on the basis of the arriving influencing variables. The determined likelihood of failure or the risk of failure then offers the basis for a decision as to whether the evaluation unit should automatically generate and output a recommendation for a suitable maintenance measure.

By way of example, there is the option to generate such a recommendation when a corresponding limit value for a risk of failure or a likelihood is exceeded. It is likewise conceivable for the method to be used to monitor multiple machines and for a recommendation to always be generated for the machine having the highest likelihood of failure.

The evaluation unit may for example be installed on the machine or provided in a control room. The evaluation unit may likewise be located on a server in a server farm in the form of a software module.

According to one preferred embodiment of the method, the estimation model determines the individual, in particular mutually independent likelihoods of failure of individual machine components. The likelihood of failure or the risk of failure of the overall machine may be ascertained from the individual likelihoods of failure. This is achieved by adding the individual likelihoods of failure and subtracting the product.

The estimation model may be or comprise a damage relevance model. The damage relevance model describes the relationship between one or more influencing variables on possible damage and/or wear of a component or of the machine. When the current input variables are supplied, this model may then be used to estimate the current advancement of wear and/or degree of damage of a component and/or machine, which may then serve as a basis for an assessment of the risk of failure or the likelihood of failure of a component and/or of the machine.

According to one preferred variant embodiment, a machine learning algorithm (MLA) is used for the damage relevance model. This makes it possible to optimize the model quality and the resulting accuracy of the estimated likelihood of failure as experience increases. The machine learning algorithm is provided in particular with data from manual samples, that is to say data collected during a manual overview of the machines, as model training sets. It is particularly expedient to generate training datasets in this way while performing manual maintenance or repair measures on the machine. It is conceivable for such a training dataset to contain at least one risk value/likelihood value for the failure of a component and/or of the machine as estimated by the respective expert, ideally together with one or more influencing variables that influence the estimated value.

A neural network or else a support vector machine is preferred as machine learning algorithm, in addition to other possible algorithms.

The manually generated training datasets are expediently supplemented with a correction factor. Such a correction factor defines a type of tolerance range for possible deviations from the estimated value. It is conceivable to define a correction factor by way of a time-dependent function, such that the value may change over the lifetime of this training set. The correction factor expediently decreases as the lifetime of the training dataset increases. If for example a sufficiently large number of training datasets have been generated and collected over a relatively long period, then the respective correction factors may be reduced, this being implemented by way of the time function.

Ideally, the damage relevance model may not only be supplied with training datasets that have been created directly for the machine currently under consideration, but rather consideration should also be given to training datasets that have been generated for identical or comparable machines or components. To this end, a database that manages all generated training datasets for different machines and components is installed. Provision is made here that the database carries out clustering of the machines and/or components in order to assign identical or similar machines/components to common clusters.

The evaluation unit may then use all training datasets of a cluster of machines/components for the model training to which the machine/component under consideration should also be assigned. This makes it possible to considerably improve the supply of training sets and thus the training quality of the damage relevance model.

In addition to the structural similarity between the machines/components, the similarity between the relevant influencing variables for the likelihood of failure may also be taken into consideration for the clustering of the machines or components. A further criterion for the clustering may also be the similarity between the machine application and accompanying operating conditions. Specifically, in this connection, the frequency of rapid load changes of the machine and/or ambient conditions of the machine may be relevant. These include for example the type and properties of the conveyed medium in the case of centrifugal pumps.

It is particularly advantageous when the damage relevance model is reset after machine maintenance performed by a person skilled in the art or after the failure of a specific component of the machine and subsequently initially retrained once again. In the best-case scenario, all available training datasets of the machine/component or of the component/machine cluster should then be used for the retraining. As an alternative, resetting of the model may be dispensed with, and said model may instead be further trained with all available training datasets.

To economize costs and resource outlay for the data acquisition, in particular with regard to machines having average failure follow-up costs, only elementary influencing variables are taken into consideration for calculating or ascertaining the likelihood/risks within the model. By way of example, the loading duration of the machine or of a specific machine component may be assigned to the elementary influencing variables. It is also conceivable to take into consideration the current operating point and/or operating point profile of the machine/of the component as an elementary influencing variable. The operating time and/or the downtime of the machine or of the component may likewise be considered as an elementary influencing variable. The same applies to the operating mode, that is to say frequency of switching procedures or load changes. A further elementary influencing variable may be the ambient temperature or medium temperature. One or more of the abovementioned influencing variables are then supplied to the damage relevance model.

The computing outlay of the evaluation unit increases as the range of influencing variables increases. The same applies in the event of using multidimensional influencing variables, that is to say influencing variables that depend on multiple parameters. It is conceivable in this connection to subject the at least one influencing variable to data preprocessing. By way of example, it is expedient here to integrate the influencing variables over one of the dependent variables. Time-dependent influencing variables may be integrated over time. The integrated influencing variable is then supplied to the damage relevance model instead of the original influencing variable.

The influencing variables may ideally be ascertained by the machine through measurement. In this case, the influencing variables may either be measured directly or else be derived from other measured values. Preference is given to performing an “online” measurement during regular machine operation, in particular continuously, periodically or else randomly. Specific influencing variables may possibly not be measured “online” for technical or economic reasons. If possible, these influencing variables should be measured and/or estimated at least once. Expediently, further characteristic information that describes the influencing variable and its behavior is created for such influencing variables not able to be measured online. Details about minimum and/or maximum values of the influencing variable and/or periodicity, etc., are conceivable here.

Externally excited vibrations, for example caused by neighboring machines, may additionally lead, in the case of a stationary machine, to greater impairment of the roller bearing geometry than in the case of a running machine.

In addition to the likelihood of failure/risk of failure, a risk tolerance value able to be defined by the user may additionally be taken into consideration to generate a recommendation for a maintenance measure. The risk tolerance value may be used to move the threshold value for the likelihood of failure or the risk of failure. The machine operator may thus specify whether a comparatively low or high risk of failure should be accepted before a maintenance measure is actually recommended and carried out.

In addition to the method according to the disclosure, the present disclosure relates to a system comprising an evaluation unit and one or more machines to be monitored. The system may optionally be equipped with a database for storing training datasets, in particular training datasets clustered according to machines/components. The evaluation unit comprises a program the instructions of which bring about the execution of the method according to the disclosure. The system is accordingly distinguished by the same advantages and properties as have already been explained above with reference to the method according to the disclosure. A repeated description may therefore be dispensed with.

Further advantages and properties of the disclosure are intended to be explained in more detail below with reference to an exemplary embodiment illustrated in the figures, in which:

### BRIEF DESCRIPTION OF THE DRAWINGS

FIG. 1: shows a table giving an overview of operation-related and operation-independent influencing variables in the case of a centrifugal pump,

FIG. 2: shows an operating hours histogram,

FIG. 3: shows a schematically illustrated artificial neural network for mapping an operating hours histogram onto the risk of failure and

FIGS. 4a and 4b: show block diagrams for explaining the method according to the disclosure.

### DETAILED DESCRIPTION

The method according to the disclosure offers a practical and useful alternative to state-oriented maintenance. In contrast thereto, the method according to the disclosure proceeds from the fact that the wear state is barely able to be acquired and assessed, but there is a relationship between the mode of operation of a centrifugal pump and its likelihood of failure.

According to the disclosure, operating variables relevant to wear or damage are incorporated into a model that is able to be tuned further through feedback from the member of maintenance staff. The damage relevance model may access a large database (cloud, big data) and thus also incorporate the feedback from a large number of maintenance staff.

A risk-based maintenance recommendation is then based on the statistics regarding the likelihood of failure of the pump unit in the near future, incorporating the “risk tolerance” of the member of maintenance staff or operator of the pump. A “cautious” member of maintenance staff, who sets a low “risk tolerance” here, may thus receive a maintenance recommendation at a relatively early time, as a result of which their maintenance strategy is “preventive” in the broadest sense. A member of maintenance staff who sets a greater “risk tolerance” receives a maintenance recommendation, in the event of comparable operating parameters, at a later time and thus risks a higher likelihood of failure; this thus entails a greater risk of performing reactive maintenance measures.

To begin with, such a system will not yet be able to access any validated data for a damage relevance model. Nevertheless, from the beginning, proceeding from the status quo, preventive and reactive maintenance, no worsening will be expected. As the number of pump populations included increases, damage relevance models become increasingly better tuned to various pump types and usage conditions. This results in increasing client use (a higher “mean time between failures” (MTBF for short) and a better degree of use of wearable supplies should be expected) and a flow of actual operating information back to the machine manufacturer.

The basic concept of such a method for risk-based maintenance recommendation may be explained as follows:

### The Machine

The machine (for example a centrifugal pump) consists of various components that are at risk of failure. In a first simplifying approach, the likelihood of failure of a component is independent of those of the other components. The likelihood of failure of the machine is then the sum of the individual likelihoods of failure minus its product.

Components and Influencing of their Likelihood of Failure

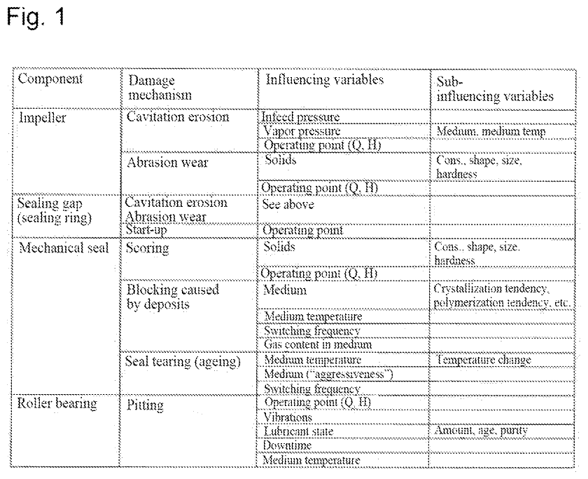

The machine components are subject to numerous influences that affect the likelihood of failure. A distinction is drawn below between operation-related and operation-independent influences. For a centrifugal pump having roller bearings, the components listed in the table in FIG. 1 and their operation-related influences are particularly relevant.

One elementary influencing variable for all components is loading duration. Three examples demonstrate that this does not always involve just the operating time of the machine:
resting time of polymers (GLRD seal) in aggressive media=downtime+operating time
duration of axial bearing loading=operating time
duration of solid-body compression in the roller bearings=downtime

Furthermore, the following operation-independent influences define the likelihood of failure of the components:
assembly quality
material quality
manufacturing tolerances
age (plastics)
prior damage (transport damage, etc.)

### Conclusions and Suggestion

The probability of failure is subject to a large number of influences. Determining all of these influencing variables precisely or measuring them online is not economical in applications with average failure follow-up costs. In order nevertheless to achieve an estimate of the likelihood of failure, the following procedure is proposed:

Determining or using measurements to acquire the elementary influencing variables for each machine (see below),

Clustering the machine population according to similarities (see below)

Determining the relationship between the elementary influencing variables and the likelihood of failure from samples for the machines of a cluster (multivariate regression analysis).

The determined relationship (likelihood of failure f(x)) is cluster-specific. It is used to make a decision about performing maintenance measures. The following decision rules are conceivable: Machines with the highest likelihood of failure are subjected to maintenance measures. The machines whose likelihood of failure is above a certain limit value are subjected to maintenance measures.

### Elementary Influencing Variables

The following influencing variables are classed as “elementary” due to their above-average influence:
loading duration
operating point (infeed pressure, end pressure, flow rate, speed)
operating time/downtime
switching frequency
media temperature
   Influencing Variables with Online Measurement

With the exception of the medium temperature, an acquisition of the elementary influencing variables may be measured directly by means of sensors or estimated. This acquisition has the character of an “online measurement” with the particular feature that the flow rate is estimated using a model of the pump.

Influencing Variables without Online Measurement

Certain influencing variables may not be able to be acquired online with reasonable effort. This will sometimes concern in particular the medium temperature and the machine vibrations. In order nevertheless to be able to take this into consideration at least roughly, at least one one-off estimate or measurement should take place. Ideally, the following additional information is available: average value, maximum value, minimum value and periodicity.

### Samples

Each maintenance measure is a sample. Maintenance measures are carried out due to a high likelihood of failure or due to an actual failure. In both cases, the likelihood of failure that is actually present is estimated. The information flows back into the database. The regression analysis is then repeated in order thus to successively improve the quality of the likelihood of failure estimation.

### Clustering

The clustering is carried out according to:
similarity between the machines (for example installation size, structural type),
similarity between the influencing variables without online measurement (for example medium temperature, vibration) and
similarity between the applications (for example medium, fast load changes).

Machines in a cluster exhibit similarities in terms of all three points.

In the underlying database, strictly speaking, it is not the machines but rather their failure-relevant components that are managed, clustered and have their likelihoods of failure calculated. Components of otherwise highly different machines may thereby also land in the same cluster. The number of clusters is thereby presumably reduced. This is advantageous in turn because more components in a cluster lead to a faster discovery of knowledge.

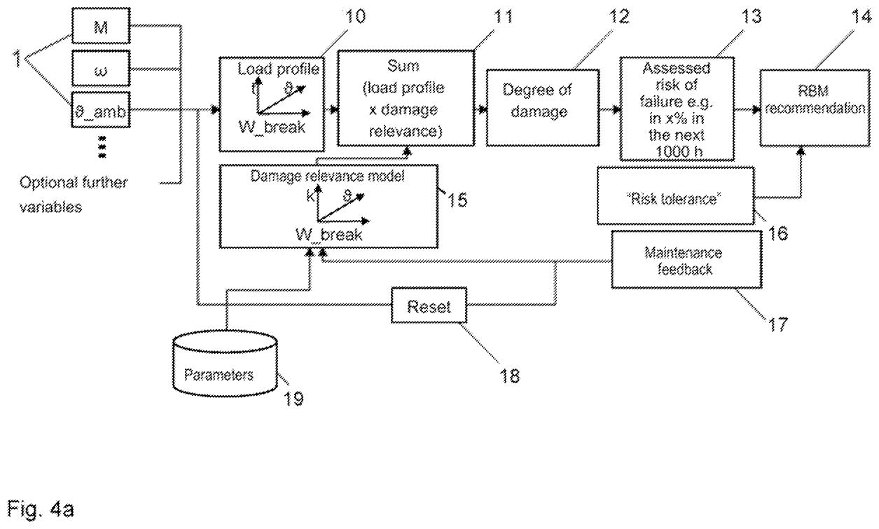

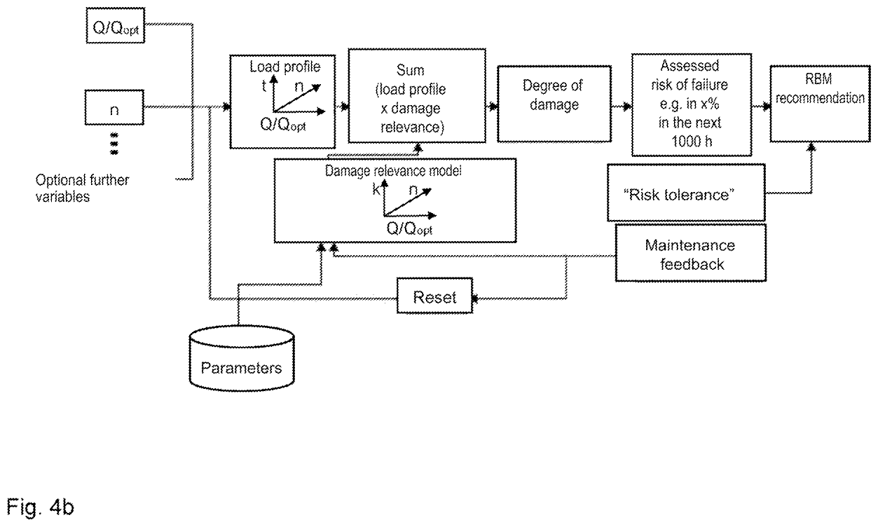

The exemplary block diagram of the method is shown in FIG. 4a or 4b. The method is intended to be explained again in more detail below with reference to a disk brake (FIG. 4a):

It is assumed here that the lifetimes of a disk brake depend essentially on the braking work carried out W_{brake}=∫(M·ω)dt and the ambient temperature ϑ_{amb}. The exact relationship is however unknown. To learn this, the following method should be applied:

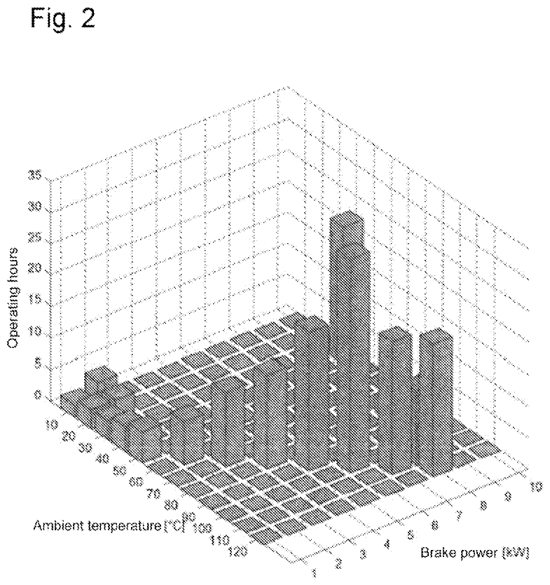

The loading-relevant influencing variables 1, here speed ω, torque M and ambient temperature ϑ_{amb} are measured. An operating hours histogram (discrete load profile) is determined from the measured data in block 10 (see FIG. 4a). One example of such an operating hours histogram is shown in FIG. 2.

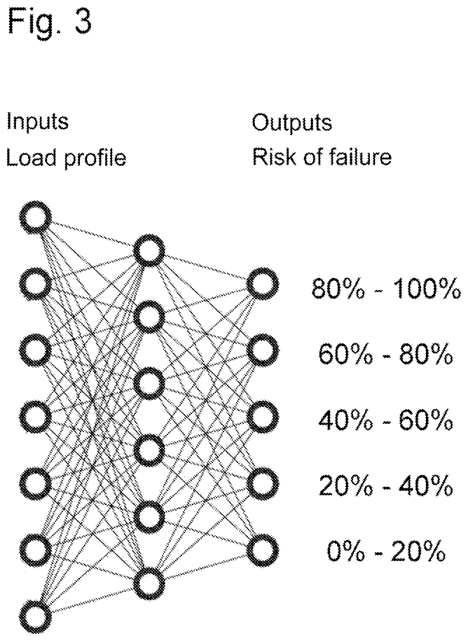

The operating hours histogram represents the loading that has taken place. The information about the order of the various loading situations is however lost. A trainable classifier 15, for example an artificial neural network or a support vector machine, is used to calculate a degree of damage 13 or a risk of failure 14 from the operating hours histogram 10. FIG. 3 shows one example of an artificial neural network for mapping an operating hours histogram onto the risk of failure.

The classifier 15 is initialized (by way of the parameters 19) such that it produces conceivable results for assumed operating hours histograms. Here, this means risks of failure that correspond to previous experience.

For actually acquired operating hours histograms, the classifier 15 is then used to calculate risks of failure and communicate them to the operator. Specifically, a recommendation for a maintenance measure 14 is displayed to the operator here. The decision as to whether and when a corresponding recommendation 14 is output may be influenced by the operator through the definable risk tolerance 16. The risk tolerance changes the threshold value of the likelihood of failure, in the event of the exceedance of which threshold value a recommendation 14 is generated.

Specifically, the following scenarios may arise:

Case 1: The operator decides to perform maintenance due to a high risk of failure.

Case 1A: The operator identifies that the risk of failure has been estimated as being too high or too low. Based on this classification, a new training dataset 17 is applied in order to improve the classifier 15. This training dataset 17 consists of the current operating hours histogram and a specification for the risk of failure. This specification is the reported risk of failure plus a correction value (for example +/−20%). The correction value may be in the form of a function of time, such that it gradually decreases over time. Experience gained over years may thereby for example be protected, since the classifier 15 is no longer changed to such an extent by new training datasets 17.

Case 1B: The operator confirms the determined risk of failure. A new training dataset 17 containing the acquired load profile and the determined risk of failure is applied.

Case 1C: The operator may provide no details about the actual risk of failure. No new training dataset is applied.

Case 2: A failure occurs. The operator reports the failure. A new training dataset 17 containing the acquired load profile and a risk of failure of 100% is applied. In any case, the classifier 15 is reset to the initial values (block 18) after maintenance or a failure and is then retrained with all available training datasets 17. As an alternative, the classifier 15 could also not be reset and instead only “further trained”.

If this method is applied by a large number of operators to a very large number of components of the same type using the IoT (Internet of things), then this quickly gives rise to a large number of new training datasets 17 and a growing database, such that the classification quickly delivers reliable and thus beneficial results.

Machines, for example pumps, may be considered to be a collection of components whose risks of failure should be determined as described above. If using a likelihood of failure instead of the risk of failure, then the following argument may be given: In a first simplifying approach, the likelihood of failure of a component is independent of those of the other components. The likelihood of failure of the machine is then the sum of the individual likelihoods of failure.

Instead of the n-dimensional load profile (FIG. 3), which quickly becomes somewhat large, a loading variable that is integrated over time may also be used instead. For example: ∫(M·ω)dt or ∫ϑ_{amb}·dt. The integration may be omitted when the loading variables are so small that there is no damage relevance.

The exemplary block diagram of FIG. 4b is structured in the same way as the embodiment according to FIG. 4a, but here the method is used for a centrifugal pump and the pump speed n and the flow rate Q are considered as input variables.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-16. (canceled)

17. A method for evaluating a necessary maintenance measure of a machine, comprising:
determining one or more influencing variables relevant to wear or damage of a machine component;
transmitting the one or more influencing variables to an evaluation unit;
receiving the one or more influencing variables by way of the evaluation unit;
ascertaining a risk of failure and/or a likelihood of failure of at least one machine component and/or of the machine by way of an estimation model to which the one or more influencing variables are supplied as input variables; and
generating a recommendation associated with a maintenance measure by way of the evaluation unit on the basis of the ascertained risk of failure and/or the likelihood of failure, wherein the machine is pump.

18. The method as claimed in claim 17, wherein the evaluation unit ascertains the likelihood of failure of the machine from likelihoods of failure of relevant components of the machine.

19. The method as claimed in claim 18, wherein the estimation model comprises a damage relevance model that describes a relevance of the one or more influencing variables on possible damage and/or wear and enables an estimate of current advancement of wear and/or degree of damage of a component and/or the machine.

20. The method as claimed in claim 19, wherein the damage relevance model of the evaluation unit is based on a machine learning algorithm to which data about a performed maintenance measure of the machine/of a machine component are provided as training datasets via an input in addition to damage-relevant influencing variables.

21. The method as claimed in claim 20, wherein one training dataset comprises a likelihood of failure and/or risk of failure for one or more components and/or the machine as estimated by a member of maintenance staff when assessing the machine and/or the component.

22. The method as claimed in claim 21, wherein a correction factor is describable as a time-dependent function, and the correction factor decreases over time.

23. The method as claimed in claim 22, wherein the training datasets are stored in a database and are retrievable by the evaluation unit or the damage relevance model when required.

24. The method as claimed in claim 23, wherein the training datasets are stored in the database for different machines and components, and the different machines and/or components are combined to form different clusters, and a similarity between the different machines and/or components and/or a similarity between their relevant influencing variables and/or the similarity between their machine application are taken into consideration as criteria for clustering.

25. The method as claimed in claim 24, wherein the damage relevance model for the model training accesses the training datasets of at least the majority of the machines and/or components of a cluster to which the machine currently under consideration is assigned.

26. The method as claimed in claim 25, wherein the damage relevance model is reset after machine maintenance has been performed and/or after a failure of the machine or of a component of the machine and then retrained with all training datasets available for the machine or the component in the assigned machine and/or component cluster.

27. The method as claimed in claim 26, wherein at least one influencing variable characterizes the loading duration of a machine component or of the machine and/or the operating point of the machine and/or the operating time/downtime of the machine/component and/or a switching frequency of the machine and/or component and/or an ambient or medium temperature of the machine.

28. The method as claimed in claim 27, wherein the evaluation unit, rather than supplying a time-dependent influencing variable, supplies an influencing variable integrated over time to the damage relevance model as an input variable.

29. The method as claimed in claim 28, wherein one or more influencing variables are acquired during the machine uptime online.

30. The method as claimed in claim 29, wherein the machine or a separate measuring unit ascertain one or more influencing variables of the machine through a one-off measurement or estimate, in connection with further characteristic information about the one or more influencing variables.

31. The method as claimed in claim 30, wherein the generation of a recommendation for a maintenance measure takes into consideration a flexibly definable risk tolerance value.

32. A system comprising:
an evaluation unit;
one or more machines to be monitored;
a database configured to store training datasets, wherein the evaluation unit contains a program the instructions of which, when executed, bring about the method as claimed in claim 31.
